(19) United States
(12) Patent Application Publication
(10) Pub. No.: US 2023/0375857 A1
(43) Pub. Date: Nov. 23, 2023

(54) SYSTEM AND PROCESS FOR EDGING OPHTHALMIC LENSES

(71) Applicant: ESSILOR INTERNATIONAL, Charenton Le Pont (FR)

(72) Inventor: David HERFORT, Charenton Le Pont (FR)

(21) Appl. No.: 18/247,973

(22) PCT Filed: Nov. 19, 2021
(86) PCT No.: PCT/EP2021/082299

§ 371 Date: Apr. 5, 2023

(30) Foreign Application Priority Data
Nov. 20, 2020 (EP) 20306423.3

(51) Int. Cl. G02C 7/02; B24B 9/14

(52) U.S. Cl. CPC G02C 7/024; B24B 9/148

(57) ABSTRACT

Disclosed is a system for edging ophthalmic lenses, including: a first database table including first data relating to referenced eyewear frames; a second database table including second data relating to corrections to apply to the first data; and a processing unit suitable to calculate an edging setpoint as a function of at least a datum read in the first database table, corrected by a datum read in the second database table, the edging setpoint being suitable to be used by an edging machine to edge an ophthalmic lens along a final outline.

### CROSS-REFERENCE TO RELATED APPLICATIONS

This application is the U.S. national phase of International Application No. PCT/EP2021/082299 filed Nov. 19, 2021, which designated the U.S. and claims priority to EP Patent Application No. 20306423.3 filed Nov. 20, 2020, the entire contents of each of which are hereby incorporated by reference.

### TECHNICAL FIELD OF THE INVENTION

The present invention generally relates to the field of eyeglasses.

It more particularly relates to a system and a process for machining the edges of ophthalmic lenses.

### BACKGROUND INFORMATION AND PRIOR ART

The technical part of the work of an optician, which consists in mounting a pair of ophthalmic lenses in a spectacle frame selected by a wearer, can be split into four main operations:
the acquisition of the shapes of the outlines of the rims of the spectacle frame selected by the wearer,
the centering of each ophthalmic lens, which consists in determining the frame of reference of the lens using centering markings provided thereon, then in suitably positioning the outline of the rim acquired beforehand in the frame of reference of the lens so that, once edged to this outline then mounted in its frame, the lens is correctly positioned with respect to the corresponding eye of the wearer and fulfils as best as possible the optical function for which it was designed,
the blocking of each lens, which consists in attaching a blocking accessory to the lens, so that the lens can be easily extracted from the centering station and then be engaged in the edging station without loss of frame of reference, then
the edging of each lens, which consists in machining this lens to the outline centered beforehand.

Here, the first operation is more particularly of interest.

This operation is generally carried out by an optician, using an outline-reading apparatus including a surface profilometer that is slid along the grooves of the frame rims.

This outline-reading apparatus then allows the shape of the bottom of the bezel to be registered in order to allow the lens to be machined in such a way that the top of its bevel has a homologous shape to that of the bezel.

The major drawback of this solution is that it requires an outline-reading apparatus to be used, the purchase and maintenance costs of which are high.

It is moreover time-consuming to implement and requires great care to be taken by the optician, this running contrary to the sought-after principle of simplicity.

It is also known from the art to prepare a pair of eyeglasses differently.

For example, it is possible for the optician to send the frame to a laboratory for edging, together with data for surfacing the lens. In this example, the laboratory is in charge of tracing the frame, surfacing the lens and edging the lens to mount it in the frame. In a variant, the optician may only send the name of the model of frame selected by the client together with data for surfacing the lens, this laboratory having a stock of frames. In both variants, the problems raised hereunder still apply.

We also know from the related art a database memorizing raw information relative to frames, but this database is only used for feasibility calculation or for a few kind of lenses. Such lenses are for instance lenses to be mounted on rimless frames or on very flexible frames or on frames having low outline dispersions.

We also note that production sites cannot take the risk of using the raw information stored in the database without control on it. The result would indeed be an inaccurate machining of the lenses, which would result on a need of re-machining the lens or of machining a new lens with other settings (the delivery being thus delayed). That are the reasons why outline-reading apparatuses are still used.

For instance, document EP 3 654 087 A1 relates to the production of eyeglasses comprising a frame and two lenses, by additive manufacturing.

U.S. Pat. Nos. 8,926,401 B and 4,656,590 A relate to a shaping method for shaping an ophthalmic lens for mounting in an eyeglass frame.

In these three documents, in view of the acquisition of the shapes of the outlines of the rims, frame data are stored in a frame database.

Creating a database with all frame information is also time consuming and is therefore not conceivable for an optician or a laboratory.

### SUMMARY OF THE INVENTION

In order to remedy this drawback, the present invention proposes a solution allowing the shape of the eyewear frame to be obtained less expensively.

To this end, the present invention provides a system for edging ophthalmic lenses, comprising:
a first database table including first data relating to referenced eyewear frames,
a second database table including second data relating to corrections to apply to said first data, and
a processing unit suitable to calculate an edging setpoint as a function of at least one of said first data, corrected by at least one of said second data, said edging setpoint being suitable to be used by a machine enabling the edging of an ophthalmic lens along a final outline.

According to the invention, the first database table comprises data that can be used by every user of centering and edging machines (optician, lens production centers . . . all named hereinafter “customer”). On the contrary, the second database table comprises data that are specific to one customer.

In other words, the idea of the invention is to separate core information and local parameters to fine-tune the data according to the specific requirements of the customer, without interfering with the requirements of other customers.

Principle of a mutualized first database table is to reduce efforts in creating it, to obtain a true reference database table with large amount of qualitative core information. This core information is determined for instance by the frame manufacturer. It is identified in the first database by an ID.

This ID may have several formats. It could be composed of:
a standard code (EAN, UPC, JAN, GTIN, . . . ), or
a combination of those standard codes, or
a combination of characteristics (for instance “the name of the frame model”, the “color” and the “size”), or
a combination of at least one of these standard code and at least one of these characteristics, or
a combination of at least one of these standard code and at least one of these characteristics and the batch code, or
a code chosen by the frame manufacturer.

An example of frame ID would be the combination of the GTIN code, the frame name, the batch number and the name of the frame manufacturer.

Principle of a separated second database table is to let each customer having his own settings. Thus, production can adjust the setpoint to its local conditions. These conditions, named “lab signature”, are for instance local temperature, local humidity, equipment used, customers habits, required polishing level, eventually the centering or edging machine used.

By extension, the use of this second database table allows cross participation and synergies between database customers for a collaborative work. In this situation, the second database table can be feed not only by a restricted qualified core team but also by every customer.

It also allows:
to facilitate the duplication of data of the first database to manage, for instance, model declination where some features (brand, name, color . . . ) are the same, but where some geometrical characteristics (shape, size . . . ) change,
to improve the data stored in the first and/or second database tables, by regularly correcting and adapting them, and/or by completing them in order to improve the efficiency of the system,
to facilitate the creation of new reference in the first database table, by looking for analog data into the database table and by proposing to copy and paste these data,
to facilitate the management of a batch of frames of the same model, by assigning specific offset parameters to this batch.

Thanks to the data recorded in the second database, the processing unit can also modify the shape of the frame trace read in the first database under certain conditions, for instance only if the characteristics of this frame meet a requirement (for instance only if the frame is in plastic).

Other preferred features of the invention are the following ones:
the system comprises a centering and blocking machine suitable to center the ophthalmic lens and to block it in a position deduced from said edging setpoint,
the system comprises an edging machine having tools suitable to automatically machine the edge of the ophthalmic lens along said final outline according to said edging setpoint,
said first database table belongs to a first database,
said second database table belongs to second database distinct from said first database,
said first database table comprises several records each associated with a kind of referenced eyewear frame (for instance a model of frame), and said records only includes invariant data,
said first database table comprises, for each kind of referenced eyewear frames, at least one of the following attributes: a frame trace, an identifier (the above mentioned ID), a geometric characteristic of this kind of referenced of eyewear frames (said frame trace being formed by the frame batch code or by any other information),
said second data comprises a corrective parameter to be applied to said first data,
the value of said corrective parameter depends on the location of said machine,
the value of said corrective parameter depends on the owner of said machine,
said second data comprises at least one feedback information relating to the accuracy of the mounting of ophthalmic lenses edged by means of said machine into eyewear frames,
said second database table is accessible to only some of the users of said first database table.

The invention also relates to a method for edging an ophthalmic lens in order to mount it into an eyewear frame, comprising steps of:
selecting an eyewear frame,
read in a first database table a first datum relating to the selected eyewear frame,
read in a second database table a second datum relating to the use of said first datum in the local conditions of a machine,
calculating a setpoint as a function of at least the first datum corrected by the second datum, and
edging said ophthalmic lens along a final outline, according to said edging setpoint, by means of said machine.

This method preferably further comprises steps of:
mounting said ophthalmic lens into said frame, and
recording a new datum into the second database table, said new datum depending on the accuracy of the mounting of said ophthalmic lens into said frame.

Preferably, the method comprises, when an eyewear frame is acquired, steps of:
determining if the kind of the acquired eyewear frame is registered in the first database table, and if not
determining for the acquired eyewear frame the value of the first data, and
recording, in a new record of the first database table, the value of the first data associated with an identifier relating to the kind of the referenced eyewear frame.

The following description with reference to the accompanying drawings, given by way of non-limiting example makes it clear what the invention consists in and how it can be reduced to practice.

### BRIEF DESCRIPTION OF THE DRAWINGS

In the accompanying drawings:

FIG. 1 is a schematic view of a system according to the invention,

FIG. 2 is a diagrammatic perspective view of a centering and blocking appliance, and

FIG. 3 is a diagrammatic perspective view of a shaper appliance.

### DESCRIPTION OF THE PREFERRED EMBODIMENTS

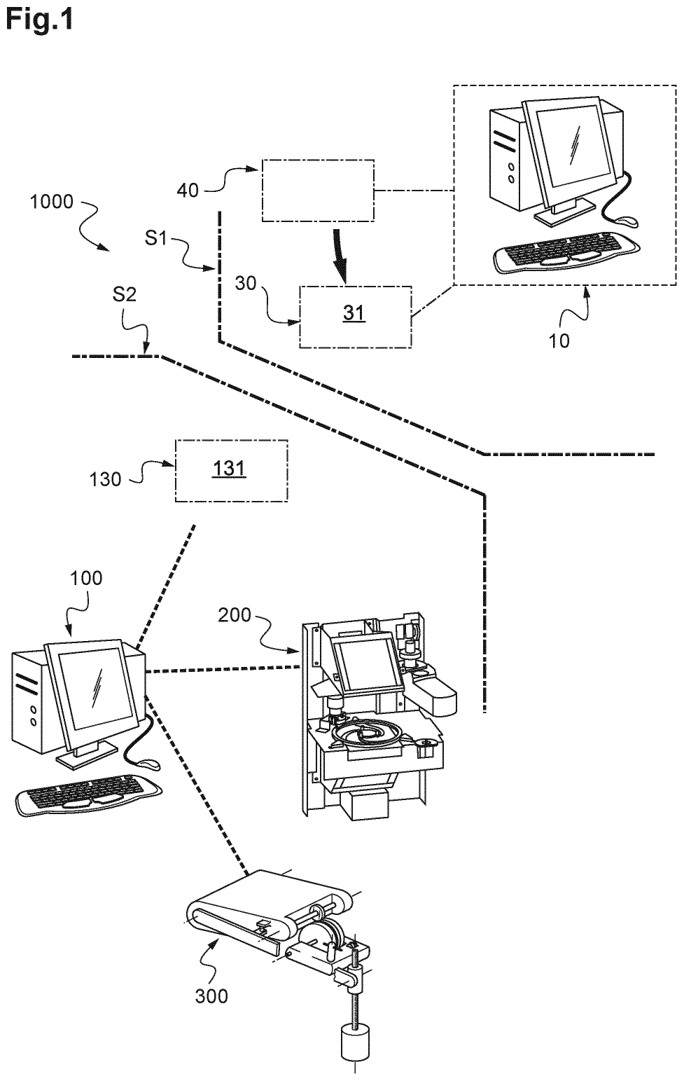

In FIG. 1 is represented a system 1000 for implementing operations enabling the edging of ophthalmic lenses.

These operations are implemented in part on the premises S1 of a central organization, and in part on the premises S2 of one or several user(s), named hereinafter “customer(s)”.

The premises S1 of the central organization are for instance an office of an ophthalmic lens manufacturer.

The premises S2 of the customer(s) are for example an office of an optician or of a lens laboratory chain.

In the following, it will be considered that the premises S2 belong to a single customer (an optician). In a variant, we will also contemplate the case where the premises S2 belong to a lens laboratory chain working with several clients (it will be specified in the text when we will do so).

In both cases, the central organization premises S1 will be adapted to work with several premises S2.

The optician's premises S2 includes appliances 100, 130, 200, 300 that enable the optician, on receiving unshaped ophthalmic lenses, to prepare those ophthalmic lenses in order to be able to mount them on the eyeglass frame selected by a the future “wearer” of the eyeglasses.

In this example, these appliances include a first database 130, a centering and blocking appliance 200, and a shaper appliance 300, all of which are controlled by a processing unit 100.

The centering and blocking appliance 200 serves to center the outlines on the ophthalmic lenses in such a manner that once they are mounted on the frame, the lenses are properly centered relative to the wearer's eyes when looking at infinity. It is also adapted to block the lens.

The shaper appliance 300 serves to shape the ophthalmic lenses 20 so as to follow those outlines.

These appliances are controlled according to edging setpoints calculated by the processing unit 100.

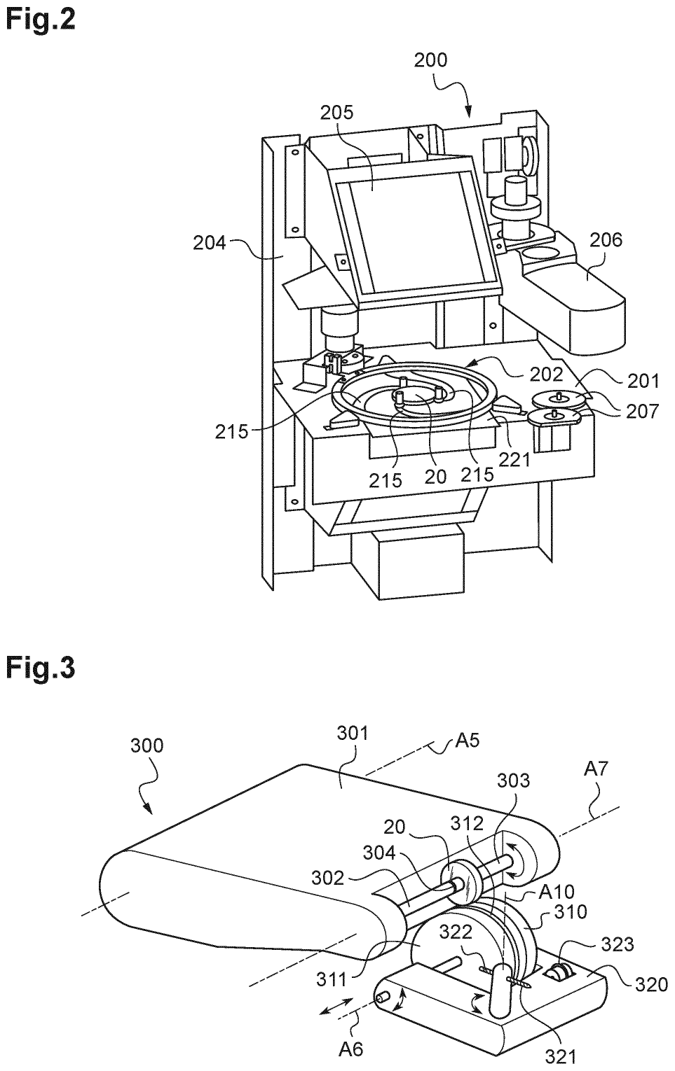

FIG. 2 shows an embodiment of a centering and blocking appliance 200 in greater detail.

This appliance is designed firstly to identify the positions of centering marks on the ophthalmic lens 20 that is to be prepared, and secondly to block the ophthalmic lens 20 by placing a blocking accessory on its front face.

This centering and blocking appliance 200 is well known to the person skilled in the art and does not itself form the subject matter of the invention described. Its architecture and its operation are described in detail, for example in patent document EP 1 722 924.

We can only specify that, as shown in FIG. 2, this appliance comprises:
a support structure 204 arranged to define a work bench 201 accessible to the optician,
a holder mechanism 202 for holding the ophthalmic lens 20 that is being prepared, the mechanism having a set of at least three concentrically-clamping jaws 215,
means for optically centering said ophthalmic lens 20,
a display screen 205 fastened to the support 204, and
blocking means 206 for blocking the ophthalmic lens 20.

In this example, the centering means comprise a transparent support plate 221 arranged beneath the holder mechanism 202, lighting means for lighting the ophthalmic lens 20 and arranged under the holder mechanism 202, and means for acquiring and analyzing the light transmitted by said ophthalmic lens 20 through the support plate 221. In this example these acquisition and analysis means comprise a digital camera. The acquisition and analysis means also include image processor means adapted to process the signal obtained at the output from the digital camera, and display means for displaying the processed signal and constituted by the display screen 205.

These centering means serve in particular to acquire an image of the ophthalmic lens 20 and of its centering marks, and to deduce therefrom the position of the optical frame of reference of the ophthalmic lens 20.

The blocking means comprise a positioning arm 206 that is preferably automatic and that is connected to the support structure 204. The positioning arm 206 is adapted to use a clamp to take one of the blocking accessories arranged on one of the receptacles 207 provided on the support stand 204 and to position the block at a location on the front face of the ophthalmic lens 20 that is determined as a function of the acquired position of the optical frame of reference of said lens.

The blocking accessory thus forms a position-identifying mark representative of the position of the optical frame of reference of the ophthalmic lens as acquired by the optical centering means. It is for engaging in a corresponding socket of the shaper appliance 300 so that the appliance acquires the position of the optical frame of reference of the ophthalmic lens.

In a variant, the blocking may be done without such an accessory. In this variant, the blocking would consist in determining the position of the optical frame of reference of the ophthalmic lens and in registering it in a memory, so as to be able to block the lens in the edging machine while keeping in memory where is this optical frame of reference. In this variant, the blocking can then be ensured directly (without using block nor sticky pads), by the mean of suction vacuum integrated to the arms of the shaper appliance.

The shaper appliance is likewise well known to the person skilled in the art and does not itself form the subject matter of the invention described. It may be embodied in the form of any machine for cutting or removing material that is suitable for modifying the outline of the ophthalmic lens 20 in order to adapt it to the shape of the selected frame.

As shown in FIG. 3, this appliance is for instance constituted by a grinder 300 that is automatic, i.e. numerically controlled. Specifically, the grinder comprises:
a rocker 301 that is controlled to pivot about a reference axis A5, in practice a horizontal axis, relative to a frame that is not shown;
a grindwheel-carrier carriage that is controlled to rotate about a grindwheel axis A6 parallel to the reference axis A5, that is controlled to move in translation along the grindwheel axis A6, and that carries grindwheels 310, 311 that are driven in rotation about the axis A6 by a motor that is not shown; and
a finishing module 320 that is controlled to pivot about the grindwheel axis A6 in order to move towards or away from the ophthalmic lens 20 and that carries means for finishing the ophthalmic lens 20.

The rocker 301 is fitted in particular with two shafts 302, 303 for clamping the ophthalmic lens 20 and driving it in rotation about a blocking axis A7 parallel to the axis A5. A first of the two shafts 302 is stationary in translation along the blocking axis A7. The second of the two shafts 303 is on the contrary movable in translation along the blocking axis A7 in order to clamp the ophthalmic lens 20 by applying axial compression thereto.

The first shaft 302 is fitted at its end with a non-removable accessory 304 for blocking the lens. The second shaft 303 is fitted with means for receiving the blocking accessory previously placed on the ophthalmic lens 20 by the arm 206 of the centering and blocking appliance 200.

The set of grindwheels carried by the grindwheel carriage includes a cylindrical shaper grindwheel 310 that serves to rough-out the ophthalmic lens 20 in such a manner as to bring its initially circular outline to a shape close to the desired shape. It also includes a beveling grindwheel 311 for forming an engagement ridge on the edge face of the ophthalmic lens 20 for mounting in a rimmed eyeglass frame.

The finishing module 320 carries a finishing wheel 323 controlled to rotate about an axis parallel to the blocking axis A7 in order to groove, chamfer, and polish the ophthalmic lens 20. It also carries a post that carries a drilling tool 321 and a milling tool 322 for acting on the ophthalmic lens 20, and that is mounted to pivot about an axis A10 orthogonal to the blocking axis A7 in order to select one or the other of these two tools in order to mill or drill the lens.

In a variant, the shaper appliance may have a different shape. For instance, it may use milling tools or dry cutting tools or combined tools . . . .

Moreover, we note that FIG. 3 shows an embodiment of a grinder but it does not represent an industrial edger which would be more likely used in a lens laboratory chain. Consequently, in a variant, the customer may use a shaper appliance different from the one shown in FIG. 3, for instance the industrial edger marketed by the Applicant under the reference “Pro-E600 edger”.

The processing unit 100 shown in FIG. 1 is used for controlling the two appliances 200, 300, and particularly to calculate edging setpoints to be sent to these appliances 200, 300.

It is represented as being remote from these appliances but, in a variant, it could be integrated in one or the other of these appliances.

The processing unit comprises a processor, a memory and various input and output interfaces.

Thanks to its output interfaces, the processing unit is suitable for communicating with the database 130, the two appliances 200, 300 and with a control unit 10 situated in the central organization premises S1.

Thanks to its memory, the processing unit stores a computer application, consisting of computer programs comprising instructions, the execution of which by the processor enables the processing unit to implement the process described below.

The control unit 10 in the central organization premises S1 comprises a processor, a memory and various input and output interfaces.

Thanks to these interfaces, the control unit 10 is able to communicate with a measuring unit 40 designed to acquire some information about eyeglasses frames and with a database 30.

The measuring unit 40 is able to acquire geometric information about eyeglasses frames.

More precisely, as it will be explained in more detail below, each time a new kind of frame (namely a new model of frame) is to be used by an optician or a customer, this geometric information is acquired and stored in the database 30. Once stored, this frame model is considered as referenced.

As explained, in the shown embodiment, the system 1000 comprises two databases, a first one illustrated in the central organization premises S1 and the second one illustrated in the optician's premises S2.

The first database, named hereinafter central database 30, comprises at least one table 31 that includes data relating to the referenced eyewear frames.

The second database, named hereinafter optician's database 130, comprises at least one table 131 that includes data relating to corrections to apply to the data stored in the central database 30.

The first database comprises data accessible to every customers and the second database comprises customized information for local use, thus allowing each customer having his own local parameters to fine-tune the information stored in the first database, according to his specific requirements.

Consequently, in the shown embodiment, the central database 30 is accessible to every customer affiliated to the central organization (opticians, lens laboratory chain . . . ) when the optician's database 130 is only accessible to the optician.

In the variant where the premises S2 are the one of a lens laboratory chain, the second database is accessible to all the clients of this lens laboratory chain.

The central database 30 may comprise various tables 31. For clarity reasons, it will be considered here that it only has a single table 31.

This table 31 comprises various attributes (the columns of the table) and several records (the rows) each associated with a model of referenced eyewear frame.

Preferably, the records only include invariant data that are registered once and for all by the central organization. In a variant, these data can be regularly corrected by the central organization when it is necessary.

One of the attributes is an identifier of the model of referenced eyewear frame.

At least another of the attributes is a geometric characteristic of this referenced eyewear frame.

In practice, the table comprises a great number of attributes to store a large amount of information that are determined and measured on a frame sample or that are given by the frame manufacturer.

In practice, the table 31 comprises at least one of the following attributes, and preferably all these attributes:
an identifier of the frame model, with ou without a batch ID,
an identifier of the frame manufacturer,
the frame type (rimless or rimmed or half-rimmed),
the frame color,
frame size information (the height and the width of the rims, the length of the bridge, the length of the temples, the groove size and shape, the pantoscopic angle . . . ),
the frame trace (that is the coordinates of a characteristic number of points that represent the shape of the outline of the rim),
the frame material,
the frame wearer gender . . . .

The frame model identifier can be a code determined by the frame manufacturer or by the central organization.

In a variant, this identifier can be determined as a function of the values of the attributes, making a unique identifier.

The optician database 130 may comprise various tables 131. For clarity reasons, it will be considered here that it has two tables 131.

The first table 131 comprises various attributes and at least one record when the second table comprises at least one attribute and several records.

The value(s) registered in the first table 131 comprise(s) a corrective parameter to be applied to the data read in the central database 30.

An example of such a corrective parameter is a coefficient for a homothety to be applied to the frame trace (enabling to take into account that the temperature conditions in the optician's workshop are different from the conditions in other sites).

This corrective parameter is here an offset A registered in the first table 131. In a variant, it could be a linear offset having the form “Ax+B” (x being for instance a polar coordinate of a point of said trace, A and B being values recorded in the first table), or even a more complex offset.

The optician's database 130 does not only comprise only one corrective parameter to be applied to a single datum recorded in the central database (for instance to the trace).

It comprises various corrective parameters to be applied to corresponding data recorded in the central database.

The value of a corrective parameter can depend on predetermined conditions. For instance, the value of the corrective parameter can differ according to the frame manufacturer, or the frame type, or the frame material . . . .

This corrective parameter value can be determined by the optician or by a machine learning algorithm, as a function of the results of the edging previously done on other lenses.

In the shown embodiment where the database 130 belongs to a single customer (the optician), the values recorded in this database depend on the location of the optician and on the location of the appliances 200, 300.

The values recorder in this database are under responsibility of the optician.

In the variant where the database 130 is shared between several clients of a lens laboratory chain, some of the values recorded in this database can depend on the locations of the client s when other depend on the location of the appliances 200, 300.

In this variant, some of the corrective parameters can be used for all the clients when other parameters are used only for a few numbers of clients. A collaborative work is preferred to contribute to the enrichment of this database.

In a preferred embodiment, the second table of the optician's database 130 comprises feedback information relating to the accuracy of the mounting of a previously edged ophthalmic lens 20 into its frame.

Indeed, after having edged a lens and after having mounted it in the selected frame, the optician can evaluate the result in terms of sizing (or in terms of fitting or aesthetic). This evaluation can be a qualitative evaluation (1 to 5 stars for instance) or a fitting appreciation (the lens is too small, small, ok, big, too big).

This feedback information can be stored in the second table and can allow to readjust the corrective parameters registered in the first table 131 when needed, considering not only one evaluation but a great number of evaluations.

This correction preferably depends on the dynamic evolution of the evaluation (enabling for instance to take into account that the tools of the shaping appliance progressively spoil).

At this step, we can explain how the process for the preparation of an ophthalmic lens is implemented.

The first step consists, for the optician, to let the wearer selecting a frame among the frame that are already referenced.

Then, the second step consists in ordering two lenses that correspond to the prescription of the wearer.

When the optician receives these lenses, the outlines of these lenses are round. That is why these lenses need to be edged so that their contours correspond to the ones of the rims of the selected frame.

Then, the optician can determine the shape of the contours along which each lens has to be edged, and the positions of the eyes of the wearer relative to the contours of the selected frame rims (named hereinafter “pupillary position”).

To determine the shape of the contours, he can use the processing unit 100 to search in the central database 30 for a record associated to the identifier of the model of the selected frame.

In this record, the processing unit read every relevant information. For instance, it can retrieve in this record the shape of the trace of each frame rim.

According to the invention, this information is not directly used, but at least a piece of this information is corrected thanks to the corrective parameters registered in the optician's database 130.

In our illustrative example, the shape of the trace is corrected by the coefficient of homothety, the value of which is registered in the first table 131 and depends for instance on the frame manufacturer, the frame material and the feedback information recorded in the second table.

On the basis of this corrected piece of information, the processing unit 100 is programmed to calculate two edging setpoints, one for each appliance 200, 300.

We note that an edging setpoint is a file that includes the parameters needed by an appliance to center and/or block and/or edge a lens.

Then, the ophthalmic lens 20 is blocked between the three jaws 215 of the centering and blocking appliance 200.

In this position, the marks on the ophthalmic lens are read in order to determine the position of its optical center.

The outline along which the lens is to be edged (named hereinafter “final outline”) is then positioned and oriented relative to the ophthalmic lens 20.

To this end, the centering and blocking appliance 200 uses the first edging setpoints in which are stored the corrected trace and the pupillary position.

Then, the manipulator arm 206 of the centering and blocking appliance 200 proceeds to block the ophthalmic lens 20. For this purpose, it takes hold of one of the blocking accessories available on one of the receptacles 207 provided on the support structure 204 and then places it on the front face of the ophthalmic lens 20 at the geometrical center (also known as the “boxing center”) of the final outline.

Finally, the optician positions the ophthalmic lens 20 with its blocking accessory between the two shafts 302 and 303 of the shaper appliance 300. The optician then uses a pushbutton to cause these two shafts to move towards each other so that the lens is sandwiched between them. The electronic unit provided in the shaper appliance 300 then controls the shaping in two operations, a roughing-out operation and a finishing operation.

For roughing-out the lens, use is made either of the cylindrical grindwheel 210 so as to reduce the radii of the lens approximately.

In order to finish the lens, one of the following is selected:
the beveling grindwheel 311 to make a bevel on the edge face of the ophthalmic lens if it is to be mounted in a rimmed eyeglass frame;
the finishing wheel 323 in order to form a groove in the edge face of the ophthalmic lens if it is to be mounted on a half-rimmed eyeglass frame; or
the drill bit 321 for drilling holes through the lens if it is to be mounted on a drilled eyeglass frame.

These operations are controlled thanks to the second edging setpoint in which is stored the corrected trace.

Once the ophthalmic lens has been shaped, the optician extracts the lens from the two shafts 302 and 303 of the appliance.

Then, he mounts it into a rim of the selected frame.

At this step, he can evaluate the result in terms of sizing or in terms of fitting.

Here, the processing unit let him choose between five fitting appreciations (the lens is too small, small, ok, big, too big).

Then, this feedback information is stored in a new record of the second table of the optician's database 130.

At this step of the description, we can explain how the central organization enriches the pool of information recorded in the central database 30.

When the central organization (or an optician) orders or receives a new frame that is not referenced, it acquires the values of every attributes of this frame (name of the model, geometric features . . . ). It can measure these values by means of the measuring unit 40 or asking for them to the frame manufacturer.

Then, a new record is created in the table 31 of the central database and this record is completed with these values. Preferably, only a specific team of the central organization is qualified to create this new record.

This invention is not restricted to the shown embodiment.

In a preferred embodiment, both databases are in the cloud, that is to say registered in web-accessible server(s).

In FIG. 1, the optician's database 130 is shown as being located in the optician's premises. Thus, according to this representation, each optician has his own database.

As a variant, this optician's database could be located in the central organization server, provided that it is accessible (at least with the right of “modification”) only to the considered optician. In this variant, one could even imagine a large database comprising separate tables each associated with a different optician.

In another variant, all the described tables 31, 131 could be located in a single database, but the read/write rights will not be the same for each user and for each table. For example, only the central organization will have these rights for accessing the table 31, and only one optician will have these rights for accessing the tables 131.

1. System for edging ophthalmic lenses, comprising:
a first database table including first data relating to referenced eyewear frames, and
a processing unit suitable to calculate an edging setpoint as a function of at least one of said first data, said edging setpoint being a file that includes the parameters needed by a machine to center or block or edge an ophthalmic lens and that is suitable to be used by the machine enabling the edging of the ophthalmic lens along a final outline,
wherein said system comprises a second database table including second data relating to corrections to apply to said first data,
wherein the processing unit is suitable to calculate said edging setpoint as a function of at least one of said first data, corrected by at least one of said second data, and
wherein the second data comprise various corrective parameters to be applied to corresponding first data.

2. The system according to claim 1, further comprising:
a centering and blocking machine suitable to center the ophthalmic lens and to block it in a position deduced from said edging setpoint, or
an edging machine having tools suitable to automatically machine the edge of the ophthalmic lens along said final outline according to said edging setpoint.

3. The system according to claim 1, wherein said first database table belongs to a first database and said second database table belongs to second database distinct from said first database.

4. The system according to claim 1, wherein said first database table comprises several records each associated with a kind of referenced eyewear frame, and wherein said records only includes invariant data.

5. The system according to claim 1, wherein said first database table comprises, for each kind of referenced eyewear frames, at least one of the following attributes:
a frame trace,
an identifier,
a geometric characteristic of this kind of referenced of eyewear frames.

6. The system according to claim 1, wherein said second data comprises a corrective parameter to be applied to said first data.

7. The system according to claim 6, wherein the value of said corrective parameter depends on the location of said machine.

8. The system according to claim 6, wherein the value of said corrective parameter is determined by an optician.

9. The system according to claim 1, wherein said second data comprises at least one feedback information relating to the accuracy of the mounting of ophthalmic lenses edged by means of said machine into eyewear frames.

10. The system according to claim 1, wherein said second database table is accessible to only some of the users of said first database table.

11. Method for edging an ophthalmic lens in order to mount it into an eyewear frame, comprising:
selecting an eyewear frame,
read in a first database table first data relating to the selected eyewear frame,
calculating a setpoint as a function of the first data, said setpoint being a file that includes the parameters needed by a machine to center or block or edge an ophthalmic lens
edging said ophthalmic lens along a final outline, according to said edging setpoint, by means of said machine,
wherein said method comprises the reading in a second database table of second data relating to the use of said first datum in the local conditions of a machine,
wherein said setpoint is calculated as a function of the first data corrected by the second data, and
wherein the second data comprise various corrective parameters to be applied to corresponding first data.

12. The method according to claim 11, further comprising steps of:
mounting said ophthalmic lens into said frame, and
recording a new datum into the second database table, said new datum depending on the accuracy of the mounting of said ophthalmic lens into said frame.

13. The method according to claim 11, wherein, said first database table comprising several records each associated with a kind of referenced eyewear frames, the method comprises, when an eyewear frame is acquired, steps of:
determining if the kind of the acquired eyewear frame is registered in the first database table, and if not
determining for the acquired eyewear frame the value of the first data, and
recording, in a new record of the first database table, the value of the first data associated with an identifier relating to the kind of the referenced eyewear frame.
